(19) United States
(12) Patent Application Publication
(10) Pub. No.: US 2020/0084413 A1
(43) Pub. Date: Mar. 12, 2020

(54) INTELLIGENT DEFENSE SURVEILLANCE CAMERA DEVICE

(71) Applicant: C-Pro Electronics CO., Ltd., Seongnam-si (KR)

(72) Inventor: Young Soo LEE, Seongnam-si (KR)

(21) Appl. No.: 15/748,712

(22) PCT Filed: Dec. 15, 2017
(86) PCT No.: PCT/KR2017/014895

§ 371 Date: Jan. 30, 2018

(30) Foreign Application Priority Data
Nov. 28, 2017 (KR) 1020170160863

(51) Int. Cl. H04N 7/18; H04N 5/225; H04N 5/247; H04N 5/232

(52) U.S. Cl. CPC H04N 7/18; H04N 5/2252; H04N 5/23299; H04N 5/247; H04N 5/2253

(57) ABSTRACT

The present invention generally relates to an intelligent defense surveillance camera device including a surveillance camera body including a camera body housing fixedly mounted to a ceiling for defense surveillance, and a housing cover coupled with the camera body housing through a screw engagement; a camera module coupling plate provided in an inside of the camera body housing of the surveillance camera body and configured to be adjustable in a vertical angle thereof; and four camera modules fixedly mounted on the camera module coupling plate. According to an intelligent defense surveillance camera device provided by the present invention, a panoramic image may be stably provided, a surveillance image with a wide angle range may be obtained, and accuracy of horizontal leveling of the four camera modules may be also improved.

### TECHNICAL FIELD

The present invention relates generally to an intelligent defense surveillance camera device. More particularly, the present invention relates to an intelligent defense surveillance camera device including a surveillance camera device providing a panoramic image by combining four captured images wherein vertical angles of all four camera modules are adjusted by adjusting a vertical angle of a camera module coupling plate, and horizontal levels of the four camera modules are precisely adjusted by using motors.

### BACKGROUND ART

In general, surveillance cameras are widely used for managing entrances and exits, and providing security by being provided in inside and outside of offices, houses, hospitals, and public buildings such as banks where security is required. Particularly, recently, surveillance cameras are mounted to monitor underground parking lots where crime occurs frequently, to monitor roads for regulating illegal parking, or to monitor residential areas where various accidents occur frequently.

Such a surveillance camera is provided in areas that are difficult to be accessed by people such as ceilings or walls. In addition to cameras that are designed to monitor an area and capture images thereof in one direction, there has been introduced a dome type surveillance camera wherein a monitoring and capturing direction is freely adjusted regardless of an installation position and space. Such a dome type surveillance camera may not distract people who see it, thus the dome type surveillance camera is mainly used indoors. Structurally, a dome housing is used for the dome type surveillance camera, and the dome housing is a cover having a semi-spherical shape and made of a transparent material to protect a camera lens.

In other words, in a conventional fixed dome camera device, a single camera is fixedly provided in an inside of a housing, and the camera monitors and captures front directional images, and transmits the captured images to a central processing part. Then, the central processing part displays image information on a screen, and stores the image information. When using such a conventional fixed dome camera, a range of an angle of view is restricted since a single camera module monitors and captures surveillance images, and the camera module for the same is fixedly provided in a housing of the fixed dome camera.

In addition, when a plurality of camera modules is provided in the conventional fixed dome camera device, capturing surveillance images having a wide angle range may be available. However, it is difficult to obtain an image of a desired direction since the plurality of camera modules is fixed. Particularly, horizontal leveling of the plurality of camera modules may be difficult since the plurality of camera modules is respectively adjusted when angles thereof are adjusted.

### DISCLOSURE

### Technical Problem

Accordingly, the present invention has been made keeping in mind the above problems occurring in the related art, and the present invention is intended to propose an intelligent defense surveillance camera device including a surveillance camera device configured with a surveillance camera body, a camera module coupling plate, and four camera modules wherein vertical angles of all four camera modules are adjusted by adjusting a vertical angle of the camera module coupling plate on which the four camera modules are fixedly mounted, and horizontal levels of the four camera modules are individually precisely adjusted by using motors respectively provided in rear parts of the four camera modules. Accordingly, a panoramic image may be stably provided since the four images of the defense surveillance area captured by the four camera modules are horizontally leveled.

In addition, another object of the present invention is to provide an intelligent defense surveillance camera device wherein a surveillance image having a wide angle range may be obtained by mounting the four camera modules on the camera module coupling plate, and accuracy of horizontal leveling of the four camera modules may be also improved by precisely adjusting a vertical angle of the camera module coupling plate.

### Technical Solution

In order to achieve the above object, according to one aspect of the present invention, there is provided an intelligent defense surveillance camera device,

the device including:

a surveillance camera body including a camera body housing fixedly mounted to a ceiling for defense surveillance, and a housing cover coupled with the camera body housing through a screw engagement;

a camera module coupling plate provided in an inside of the camera body housing of the surveillance camera body, and configured to be adjustable in a vertical angle thereof; and

four camera modules fixedly mounted on the camera module coupling plate.

Preferably, the camera body housing may have a cylindrical shape and further include:

a pair of shaft seats fixedly disposed on an inner surface of the camera body housing and diametrically facing each other so that the pair of shaft seats are coupled with rotating shafts of the camera module coupling plate; and

an angle adjustment part provided on the camera body housing in front of a center between the pair of shaft seats such that the camera module coupling plate coupled to the pair of shaft seats is adjustable in the vertical angle thereof.

More preferably, the angle adjustment part may be provided on the inner surface of the camera body housing, and include:

a nut bushing fixedly mounted on a bottom of the camera body housing and having internal threads;

a spring disposed on an upper end of the nut bushing; and

an angle adjustment screw engaged with the internal threads of the nut bushing by passing through a front part of the camera module coupling plate and the spring disposed below the camera module coupling plate.

More preferably, the angle adjustment part may be configured

such that the camera module coupling plate is adjustable in the vertical angle thereof due to elastic force of the spring supporting the camera module coupling plate, the elastic force being changed by tightening and loosening the angle adjustment screw, and surveillance directions in a defense surveillance area of the four camera modules are set by adjusting the vertical angle of the camera module coupling plate.

Preferably,

the camera module coupling plate may have a semi-circular shape, with the four camera modules (150) being radially fixedly mounted thereon.

More preferably, the camera module coupling plate may include:

a pair of rotating shafts rotating by being coupled with the pair of shaft seats of the camera body housing; and

a through hole through which the angle adjustment screw passes and is engaged with the internal threads of the nut bushing of the angle adjustment part.

More preferably, the four camera modules may include:

four cameras radially disposed on the camera module coupling plate to capture images of the defense surveillance area;

and

motors respectively provided in rear parts of the four cameras to individually precisely adjust horizontal levels of each of the four cameras, the horizontal levels being changed by adjusting the vertical angle of the camera module coupling plate.

More preferably,

the intelligent defense surveillance camera device may provide a panoramic image of the defense surveillance area by combining four images of the defense surveillance area which are captured by the four camera modules, set the surveillance directions of the four camera modules by adjusting the vertical angle of the camera module coupling plate, and individually precisely adjust the horizontal levels of each of the four cameras by remotely controlling the motors respectively provided in the rear parts of the four cameras of the four camera modules.

### Advantageous Effects

According to an intelligent defense surveillance camera device provided by the present invention, a surveillance camera device includes a surveillance camera body, a camera module coupling plate, and four camera modules wherein vertical angles of all four camera modules are adjusted by adjusting a vertical angle of the camera module coupling plate on which the four camera modules are fixedly mounted, and horizontal levels of the four camera modules are individually precisely adjusted by using motors respectively provided in rear parts of the four camera modules. Accordingly, a panoramic image may be stably provided since the four images of the defense surveillance area captured by the four camera modules are horizontally leveled.

In addition, according to the present invention, a surveillance image having a wide angle range may be obtained by mounting the four camera modules on the camera module coupling plate, and accuracy of horizontal leveling of the four camera modules may be also improved by precisely adjusting a vertical angle of the camera module coupling plate.

### DESCRIPTION OF DRAWINGS

FIG. 1 is an exploded perspective view showing a configuration of an intelligent defense surveillance camera device according to an embodiment of the present invention.

FIG. 2 is a perspective view of a housing of a camera body of the intelligent defense surveillance camera device according to an embodiment of the present invention.

FIG. 3 is a perspective view of a camera module coupling plate of the intelligent defense surveillance camera device according to an embodiment of the present invention.

FIG. 4 is a perspective view showing a state where the housing of the camera body is coupled with the camera module coupling plate of the intelligent defense surveillance camera device according to an embodiment of the present invention.

FIG. 5 is a view showing a coupling configuration of an angle adjusting part of the intelligent defense surveillance camera device according to an embodiment of the present invention.

FIGS. 6A and 6B are views showing a configuration of adjusting a vertical angle of the intelligent defense surveillance camera device according to an embodiment of the present invention.

FIGS. 7A-7D are views showing the entire appearance configuration of the intelligent defense surveillance camera device according to an embodiment of the present invention.

### MODE FOR INVENTION

Hereinafter, the present invention will now be described more fully with reference to the accompanying drawings, in which exemplary embodiments of the present invention are shown such that one of ordinary skill in the art may easily work the invention. In the description of the present invention, certain detailed explanations of related art are omitted when it is deemed that they may unnecessarily obscure the essence of the invention.

Like reference numerals denote like elements throughout.

In addition, in the present specification, when a constituent element “contacts” or is “connected” to other constituent element, the constituent element contacts or is connected to the other constituent element not only directly but also “indirectly” through at least one other constituent element interposed therebetween. Also, when a part may “include” a certain constituent element, unless specified otherwise, it may not be construed to exclude another constituent element but may be construed to further include other constituent elements.

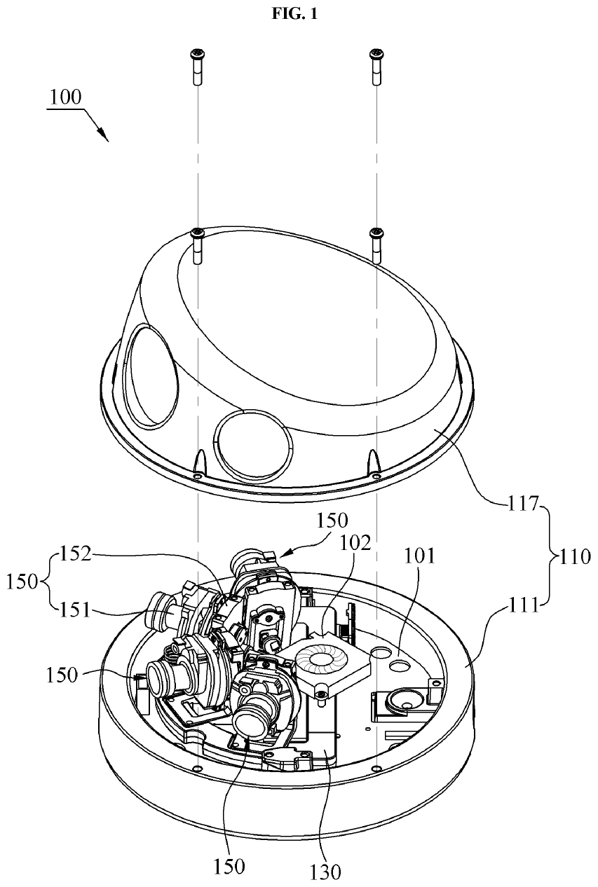

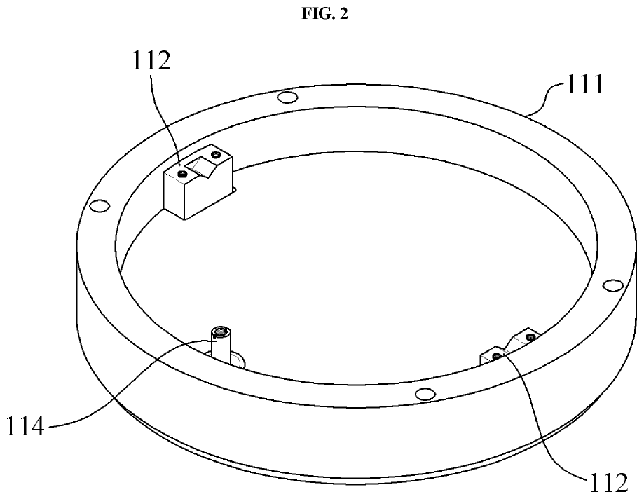

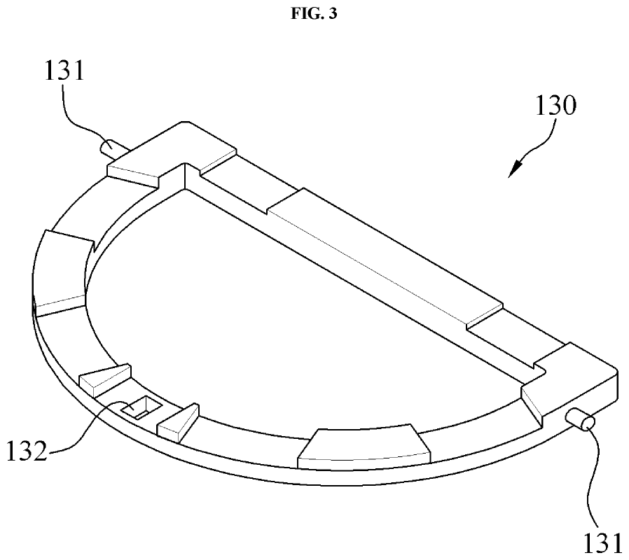

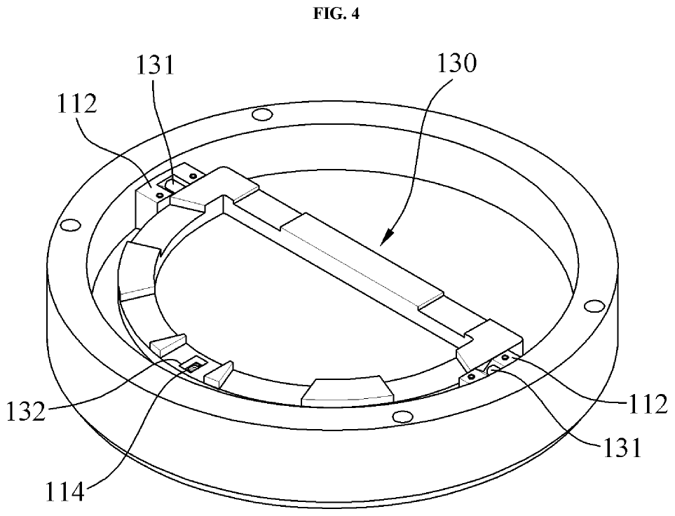

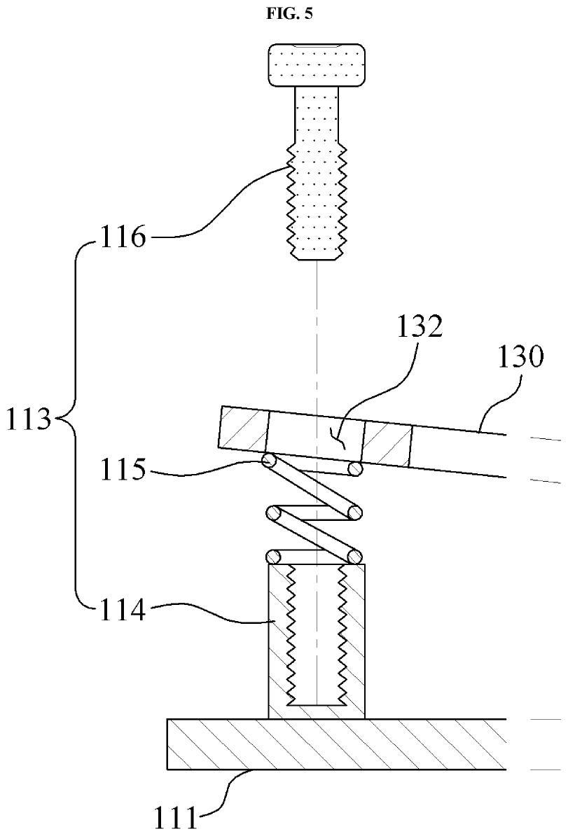

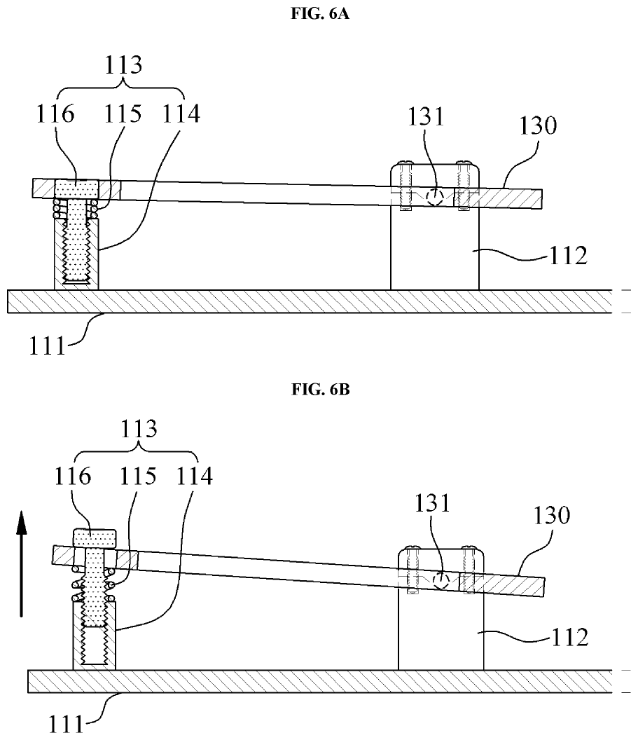

FIG. 1 is an exploded perspective view showing a configuration of an intelligent defense surveillance camera device according to an embodiment of the present invention, FIG. 2 is a perspective view of a housing of a camera body of the intelligent defense surveillance camera device according to an embodiment of the present invention, FIG. 3 is a perspective view of a camera module coupling plate of the intelligent defense surveillance camera device according to an embodiment of the present invention, FIG. 4 is a perspective view of a coupling state of the housing of the camera body with the camera module coupling plate the intelligent defense surveillance camera device according to an embodiment of the present invention, FIG. 5 is a view showing a coupling configuration of an angle adjusting part of the intelligent defense surveillance camera device according to an embodiment of the present invention, and FIGS. 6A and 6B are views showing a configuration of adjusting a vertical angle of the intelligent defense surveillance camera device according to an embodiment of the present invention. As shown in respective FIGS. 1-5, 6A, and 6B, an intelligent defense surveillance camera device 100 according to an embodiment of the present invention may include a surveillance camera body 110, a camera module coupling plate 130, and four camera modules 150.

The surveillance camera body 110 is a camera housing including a camera body housing 111 fixedly mounted to a ceiling for defense surveillance, and a housing cover 117 coupled with the camera body housing 111 through a screw engagement. As shown in FIGS. 2 and 4, the camera body housing 111 of the surveillance camera body 110 may have a cylindrical shape, and further includes a pair of shaft seats 112 disposed on an inner surface of the camera body housing 111 to diametrically face each other so that the pair of shaft seats 112 are coupled with rotating shafts of the camera module coupling plate 130 which will be described later, and an angle adjustment part 113 disposed on the camera body housing in front of a center between the pair of shaft seats 112 so that the camera module coupling plate 130 provided on the pair of shaft seats 112 is adjustable in a vertical angle thereof. Herein, a digital image processing circuit 101 is fixedly provided on a bottom of the camera body housing 111 to perform image processing of images captured by cameras 151 of the four camera modules 150 which will be described later. The digital image processing circuit 101 corresponds to a conventional configuration of performing image processing for the surveillance camera device 100, thus an unnecessary description is omitted.

In addition, as shown in FIG. 5, the angle adjustment part 113 may be fixedly provided on the bottom of the camera body housing 111, and include a nut bushing 114 having internal threads, a spring 115 disposed on an upper end of the nut bushing 114, and an angle adjustment screw 116 engaged with the internal threads of the nut bushing 114 by passing through a front part of the camera module coupling plate 130 and the spring disposed below the camera module coupling plate 130. As shown in FIGS. 6A and 6B, since elastic force of the spring 115 supporting the camera module coupling plate 130 is changed by tightening and loosing the angle adjustment screw 116, the vertical angle of the camera module coupling plate 130 is adjusted. Surveillance directions in a defense surveillance area of the four camera modules 150 may be set by adjusting the vertical angle of the camera module coupling plate 130. FIG. 6A shows a state where a vertical angle of the angle adjustment part 113 is not adjusted, and FIG. 6B shows a state where a vertical angle of the angle adjustment part 113 is adjusted by elastic force of the spring 115.

The camera module coupling plate 130 is disposed inside the camera body housing 111 of the surveillance camera body 110, coupled with the pair of shaft seats 112 of the camera body housing 111, and configured to be adjustable in a vertical angle thereof. As shown in FIG. 3, the camera module coupling plate 130 may have a semi-circular shape on which four camera modules 150 which will be described later are radially fixedly mounted. Herein, the camera module coupling plate 130 may include a pair of rotating shafts 131 that rotate by being coupled with the pair of shaft seats 112 of the camera body housing 111, and a through hole 132 through which the angle adjustment screw 116 of the angle adjustment part 113 passes and is engaged with the internal threads of the nut bushing 114. Herein, a fan 102 for heat dissipation is provided in a rear part of the camera module coupling plate 130, in other words, on rear parts of where the four camera modules 150 are provided.

The four camera modules 150 are fixedly mounted on the camera module coupling plate 130 for observing a defense surveillance area and capturing images thereof. The four camera modules 150 may include four cameras 151 radially disposed on the camera module coupling plate 130 to capture images of the defense surveillance area, and motors 152 respectively provided in rear parts of the four cameras 151 so that horizontal levels of the four cameras 151 are individually precisely controlled when horizontal levels of the four cameras 151 are changed as the vertical angle of the camera module coupling plate 130 is adjusted. Herein, each camera 151 of the four camera modules 150 may be configured to have a range of an angle of view being 60 degrees so that the defense surveillance area may be observed and captured in a wide angle range. Herein, the four camera modules 150 are configurations for observing the defense surveillance area and capturing images thereof in a wide angle range, and refer to an identical or similar configuration and function applied to a conventional surveillance camera device, thus an unnecessary description is omitted.

In other words, the surveillance camera device 100 including the surveillance camera body 110, the camera module coupling plate 130, and the four camera modules 150 provides a panoramic image of the defense surveillance area by combining images captured by the four camera modules 150, sets surveillance directions of the four camera modules 150 by adjusting the vertical angle of the camera module coupling plate 130, and individually precisely adjusts horizontal levels of each the four camera modules 150 by remotely controlling the motors 152 provided in the rear parts of the cameras 151 of the four camera modules 150. Herein, the surveillance camera device 100 may control to output four images by using a single IP whereby four surveillance images are combined in a panoramic image.

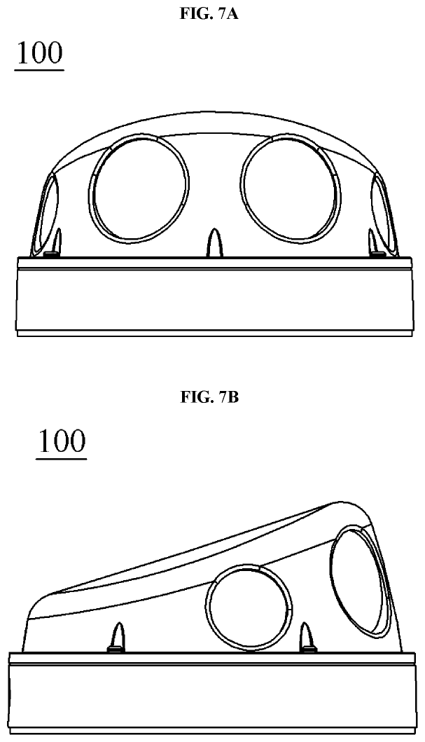

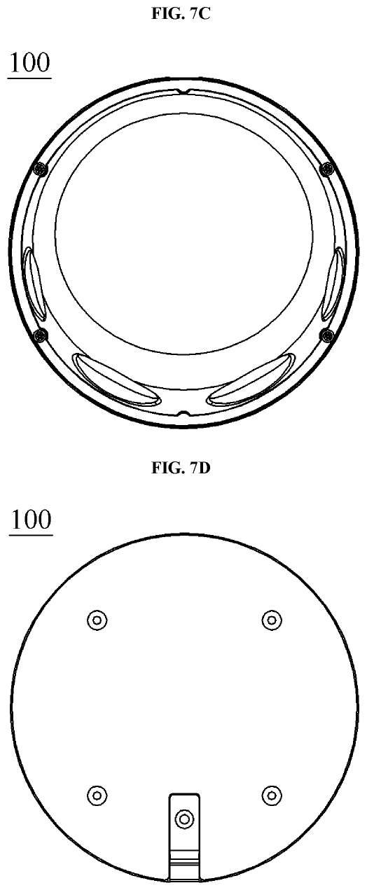

FIGS. 7A-7D are views showing the entire appearance configuration of the intelligent defense surveillance camera device according to an embodiment of the present invention. FIG. 7A is a front configuration view of the surveillance camera device 100, FIG. 7B is a lateral configuration view of the surveillance camera device 100, FIG. 7C is a planar configuration view of the surveillance camera device 100, and FIG. 7D is a bottom configuration view of the surveillance camera device 100.

As described above, an intelligent defense surveillance camera device according to an embodiment of the present invention includes a surveillance camera device configured with a surveillance camera body, a camera module coupling plate, and four camera modules wherein vertical angles of all four camera modules are adjusted by adjusting a vertical angle of the camera module coupling plate on which the four camera modules are fixedly mounted, and horizontal levels of the four camera modules are individually precisely adjusted by using motors respectively provided in rear parts of the four camera modules. Accordingly, a panoramic image may be stably provided since the four images of the defense surveillance area captured by the four camera modules are horizontally leveled. Particularly, since a surveillance image with a wide angle range may be obtained by disposing the four camera modules on the camera module coupling plate, accuracy of horizontal leveling of the four camera modules may be also improved by precisely adjusting a vertical angle of the camera module coupling plate.

Although a preferred embodiment of the present invention has been described for illustrative purposes, those skilled in the art will appreciate that various modifications, additions and substitutions are possible, without departing from the scope and spirit of the invention as disclosed in the accompanying claims.

### DESCRIPTION OF THE REFERENCE NUMERALS IN THE DRAWINGS

100: intelligent defense surveillance camera device according to an embodiment of the present invention
101: digital image processing circuit
102: fan
110: surveillance camera body
111: camera body housing
112: pair of shaft seats
113: angle adjustment part
114: nut bushing
115: spring
116: angle adjustment screw
117: housing cover
130: camera module coupling plate
131: pair of rotating shafts
132: through hole
150: camera module
151: camera
152: motor

1. An intelligent defense surveillance camera device, the device comprising:
a surveillance camera body including a camera body housing fixedly mounted to a ceiling for defense surveillance, and a housing cover coupled with the camera body housing through a screw engagement;
a camera module coupling plate provided in an inside of the camera body housing of the surveillance camera body, and configured to be adjustable in a vertical angle thereof; and
four camera modules fixedly mounted on the camera module coupling plate.

2. The intelligent defense surveillance camera device of claim 1,
wherein the camera body housing has a cylindrical shape and further includes:
a pair of shaft seats fixedly disposed on an inner surface of the camera body housing and diametrically facing each other so that the pair of shaft seats are coupled with rotating shafts of the camera module coupling plate; and
an angle adjustment part provided on the camera body housing in front of a center between the pair of shaft seats so that the camera module coupling plate coupled with the pair of shaft seats is adjustable in the vertical angle thereof.

3. The intelligent defense surveillance camera device of claim 2, wherein the angle adjustment part is provided on the inner surface of the camera body housing, and includes:
a nut bushing fixedly mounted on a bottom of the camera body housing and having internal threads;
a spring disposed on an upper end of the nut bushing and
an angle adjustment screw engaged with the internal threads of the nut bushing by passing through a front part of the camera module coupling plate and the spring disposed below the camera module coupling plate.

4. The intelligent defense surveillance camera device of claim 3, wherein the angle adjustment part is configured such that the camera module coupling plate is adjustable in the vertical angle thereof due to elastic force of the spring supporting the camera module coupling plate, the elastic force being changed by tightening and loosening the angle adjustment screw, and surveillance directions in a defense surveillance area of the four camera modules are set by adjusting the vertical angle of the camera module coupling plate.

5. The intelligent defense surveillance camera device of claim 1, wherein the camera module coupling plate has a semi-circular shape, with the four camera modules being radially fixedly mounted thereon.

6. The intelligent defense surveillance camera device of claim 5, wherein the camera module coupling plate includes:
a pair of rotating shafts rotating by being coupled with the pair of shaft seats of the camera body housing; and
a through hole through which the angle adjustment screw passes and is engaged with the internal threads of the nut bushing of the angle adjustment part.

7. The intelligent defense surveillance camera device of claim 6, wherein the four camera modules include:
four cameras radially disposed on the camera module coupling plate to capture images of the defense surveillance area; and
motors respectively provided in rear parts of the four cameras to precisely adjust horizontal levels of each of the four cameras, the horizontal levels being changed by adjusting the vertical angle of the camera module coupling plate.

8. The intelligent defense surveillance camera device of claim 7, wherein the intelligent defense surveillance camera device provides a panoramic image of the defense surveillance area by combining four images of the defense surveillance area which are captured by the four camera modules, sets the surveillance directions of the four camera modules by adjusting the vertical angle of the camera module coupling plate, and precisely adjusts the horizontal levels of each of the four cameras by remotely controlling the motors respectively provided in the rear parts of the four cameras of the four camera modules.
